(19) United States
(12) Patent Application Publication
(10) Pub. No.: US 2025/0033604 A1
(43) Pub. Date: Jan. 30, 2025

(54) Windshield cleaning implement

(71) Applicant: Andrew Frank Colman, PORTSMOUTH, RI (US)

(72) Inventor: Andrew Frank Colman, PORTSMOUTH, RI (US)

(21) Appl. No.: 18/213,859

(22) Filed: Jun. 25, 2023

(51) Int. Cl. B60S 3/04; B08B 1/14; B08B 1/30

(52) U.S. Cl. CPC B60S 3/045; B08B 1/143; B08B 1/30

(57) ABSTRACT

A windshield cleaning implement for scrubbing insects and debris from a windshield that incorporates a hand-held ergonomic rubber tool that can be used ambidextrously. A disposable glass wipe is used to wrap around the bottom side of the rubber tool as well as the sides. The glass wipe is held in place with the hand that is holding onto the rubber tool. There is a built-in grip with four finger holes inside and the thumb on the outside. The bottom of the rubber tool has a raised surface with small perforations to provide friction when rubbed on the outside of the windshield which removes the insects and debris. The rubber material that comprises the cleaning tool is designed to provide friction on the windshield without abrading the windshield. The disposable glass wipes used are made to be used on car windshields/windows and are not abrasive.

### BACKGROUND/SUMMARY

Cars and trucks are impacted by insects colliding with the vehicle windshield. The resulting insect residue on windshields can be messy and especially difficult to remove if the insect debris has become dried out.

Quite often, wipers will simply smear the insect debris across the windshield. In the event the wiper fluid is depleted, things are even more difficult. When remote from a gas station there is the inconvenience of the need to locate a source of water/windshield fluid for cleaning the windshield. The friction of the windshield wiper used in conjunction with the wiper fluid is often not enough to remove the bug debris.

The present invention relates to an implement that allows a user to remove the bug debris in those situations when wipers and fluid alone are not enough to clean the windshield, when remote from a gas station that provides the necessary cleaning fluid and squeegee or when there is no water or wiper fluid available.

### PRIOR ART

The prior art relates to scrubbing devices and squeegees. To date, methods to address difficult-to-remove debris comprise use of windshield wiper fluid, dispensed while operating windshield wipers (this often smears the debris), and ice scrapers and squeegees.

A review of the prior art reveals a few tools that purportedly facilitate cleaning a windshield or other glass surface. For example, U.S. Pat. No. 4,107,812 issued to Lantto discloses a squeegee having a removable, replaceable blade at an end of an elongated handle. The blade includes a wiper slidably mounted thereon for removing excess moisture.

U.S. Pat. No. 4,841,854 issued to Bubley discloses a screen-printing squeegee having a mechanism for adjusting the stiffness of a wiping blade.

U.S. Pat. No. 6,092,255 issued to Kim discloses a combination scraper, squeegee and sponge wherein the scraper and squeegee blade each include a curved edge adapted to conform to bubble windshields.

U.S. Pat. Application number 2004/0156991 to Brown et al, discloses a dispenser that is attached to or made part of a wiper blade that disperses hydrophobic or hydrophilic surface treatment material to the windshield for either repelling water or wetting the windshield, respectively. This involves a modification of the actual wiper blade that could accumulate debris.

U.S. Pat. No. 6,687,946 discloses a wiper blade attachment with pressurized inflatable scrubbing member. The device is pressurized by windshield wiper fluid and permits seepage of fluid onto the windshield. This is a semi-permanent attachment and is not disposable.

It would be advantageous to have a windshield cleaning implement that does not use a windshield wiper, semi-permanent or disposable or that does not include a squeegee or a variation there of. The hand-held cleaning implement and canister of disposable car glass wipes are easily stored in the vehicle. The cleaning implement and disposable wipes can be used without a bucket of cleaning fluid and a squeegee like you would find at a gas station. The windshield can be cleaned at any location and at any time: home, rest area, or parking lot using just the cleaning tool and the disposable glass wipes.

### SUMMARY OF THE INVENTION

The present invention relates to a cleaning implement that is made of rubber and is ergonomically designed to be held by either hand. It is used in conjunction with a vehicle glass wipe that wraps around the bottom and sides of the cleaning implement, and held in place by the hand that is holding the cleaning implement. The bottom of the cleaning implement has a raised center with a pattern of raised nubs that provide the necessary friction when rubbed on the windshield.

It is therefore an object of the present invention to provide a windshield cleaning implement that allows a user to clean a windshield without the need for windshield washer fluid and a squeegee or wipers.

### DESCRIPTION OF THE DRAWINGS

FIG. 1 is a front view of the cleaning implement

FIG. 2 is a right side view of the cleaning implement

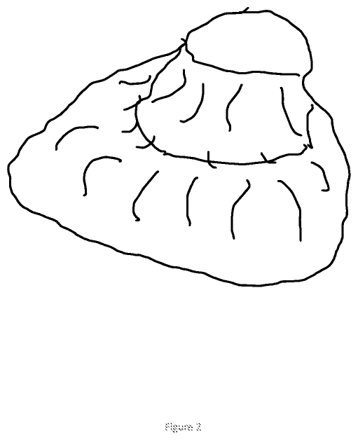

FIG. 3 is a bottom view of the cleaning implement

FIG. 4 is a left side view of the cleaning implement

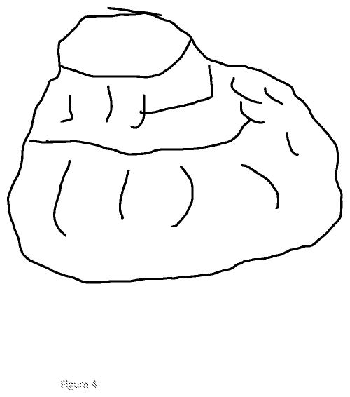

FIG. 5 is a rear view of the cleaning implement

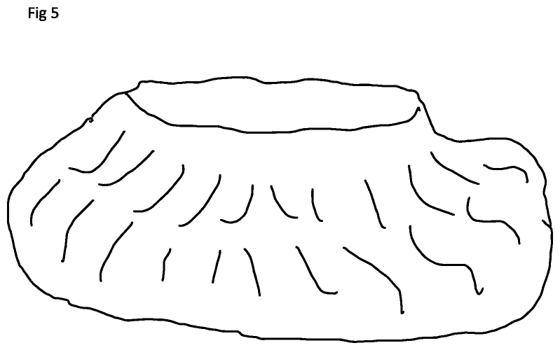

FIG. 6 is a top view of the cleaning implement

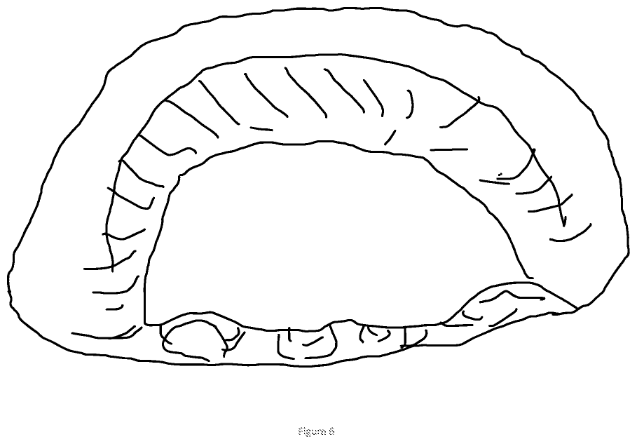

### DETAILED DESCRIPTION OF THE INVENTION

The present invention relates to a cleaning implement made of rubber that is ergonomically designed and can be grasped comfortably with either hand. It is to be used in conjunction with disposable windshield glass wipes that expedite the removal of dried material from windshields such as insect debris.

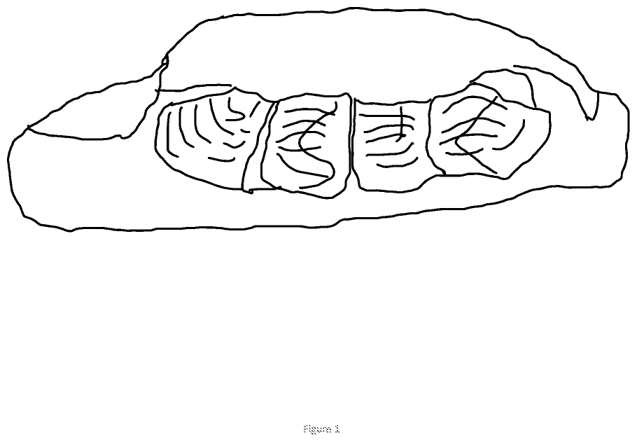

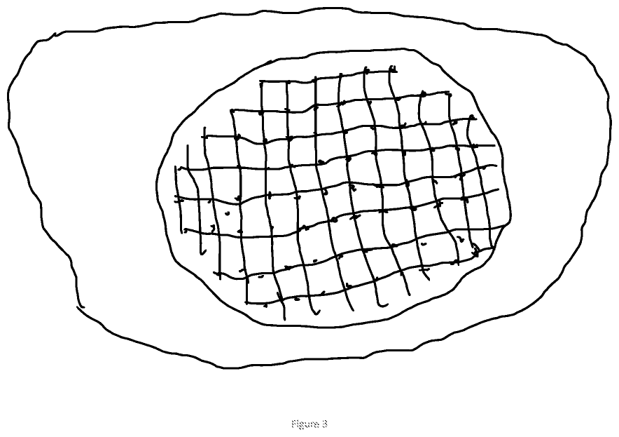

To clean a windshield, a user wraps a disposable windshield glass wipe around the bottom and sides of the rubber cleaning implement. The user then places one of their hands into the four finger holes molded on the front of the cleaning implement (FIG. 1) and holds onto the disposable glass wipe. The palm of the same hand is also used to hold onto the wipe and to apply pressure to the windshield as needed. The bottom side of the cleaning implement (FIG. 3) has a raised surface with small nubs that provide friction when the wipe is pressed onto the windshield and moved back and forth.

When the cleaning implement, that is wrapped by the disposable wipe, is pressed downward onto the windshield, the force that is applied causes the rubber nubs to create enough friction to loosen and remove the dried insect and other debris from the windshield. There is no water or windshield fluid needed to clean the windshield, just the cleaning implement and disposable glass wipes. Thereby providing the opportunity to clean a bug smeared windshield at any time and any place without the need to find a gas station that has windshield cleaning supplies such as fluid and a squeegee.

1. A windshield cleaning implement comprised of a rubber ergonomically designed clam shell shape that can be comfortably held and used by either your right or left hand; to be used in conjunction with disposable glass wipes. The disposable glass wipe is wrapped around the bottom side of the rubber tool and held onto by the hand that is holding onto the tool; the four fingers, that fit into the finger slots, are also used to hold the disposable wipe in place as well as the thumb and palm of the hand gripping the tool. Once the disposable windshield glass wipe is wrapped underneath the tool (where the raised cleaning rubber nubs are located, that provide the necessary friction on the debris when downward pressure is applied) and properly held in place by the four fingers, thumb and palm of the hand, pressure can be applied to the windshield and the tool is to be moved back and forth in a straight line or circular motion over the debris to be removed. In the case of severely dried debris, a new disposable wipe may have to replace the previously used wipe to properly remove debris. Once the debris is removed and the desired windshield clarity has been achieved, the used wipe is simply thrown away.
